(19) United States
(12) Patent Application Publication
(10) Pub. No.: US 2015/0134932 A1
(43) Pub. Date: May 14, 2015

(54) STRUCTURE ACCESS PROCESSORS, METHODS, SYSTEMS, AND INSTRUCTIONS

(71) Applicant: Cameron B. Mcnairy, Windsor, CO (US)

(72) Inventor: Cameron B. Mcnairy, Windsor, CO (US)

(21) Appl. No.: 13/977,152

(22) PCT Filed: Dec. 30, 2011
(86) PCT No.: PCT/US2011/068238

§ 371 Date: Jun. 28, 2013

(51) Int. Cl. G06F 15/76; G06F 12/08

(52) U.S. Cl. CPC G06F 15/76; G06F 12/0875; G06F 2015/765; G06F 2212/452
USPC 712/37

(57) ABSTRACT

A method of an aspect, which may be performed responsive to one or more structure access instructions, includes changing a state of a portion of a structure of a processor to a sequestered state. In the sequestered state, components of the processor are not able to access the portion of the structure but are able to access one or more other portions of the structure. Non-architecturally visible data in the portion of the structure is modified, while the portion of the structure is in the sequestered state. The state of the portion of the structure is then changed from the sequestered state to a non-sequestered state, after the non-architecturally visible data in the portion of the structure has been modified. Other methods, apparatus, systems, and instructions are also disclosed.

### BACKGROUND

1. Field

Embodiments relate to processors. In particular, embodiments relate to processors to sequester and modify micro-architectural data within structures of processors responsive to structure access instructions.

2. Background Information

Processors having various instruction set architectures (ISAs) are known in the art. An ISA generally represents the part of the architecture of the processor related to programming. The ISA commonly includes the native instructions, architectural registers, data types, addressing modes, memory architecture, interrupt and exception handling, and other portions of the architecture of the processor that are visible to software and/or a programmer. By way of example, architectural registers (e.g., general-purpose registers) may be specified by general-purpose macroinstructions of application programs to identify data that is to be operated on.

The ISA is distinguished from the micro-architecture of the processor. The micro-architecture of the processor generally represents the particular processor design techniques selected to implement the ISA. Processors with different micro-architectures may share a common ISA. Most processors have a number of micro-architectural structures. A few examples of such micro-architectural structures include, but are not limited to, caches, translation lookaside buffers, reorder buffers, retirement registers, etc. Such micro-architectural structures, and various different types of micro-architectural or non-architecturally visible data with such structures, are commonly not accessible, or only accessible in quite limited ways, to macroinstructions.

### BRIEF DESCRIPTION OF THE SEVERAL VIEWS OF THE DRAWINGS

The invention may best be understood by referring to the following description and accompanying drawings that are used to illustrate embodiments. In the drawings:

FIG. 1 is a block diagram of an embodiment of a processor having an embodiment of logic that is operable to perform a structure access operation responsive to an embodiment of a structure access instruction.

FIG. 2 is a block flow diagram of an embodiment of a method that may be performed in response to embodiments of one or more structure access instructions.

FIG. 3 is a block diagram of an embodiment of a cache that may be modified by one or more structure access instructions.

FIG. 4 is a block diagram of an embodiment of a structure access instruction.

FIG. 5 is a block diagram of a detailed example embodiment of a structure access operand.

FIG. 6 is a block diagram of an embodiment of a structure having a privileged access state that allows higher-privilege component(s) to access a portion of the structure and prevents lower-privilege components from accessing the portion of the structure.

FIG. 7 is a block diagram of an article of manufacture including a machine-readable storage medium storing one or more structure access instructions.

FIG. 8A is a block diagram illustrating both an exemplary in-order pipeline and an exemplary register renaming, out-of-order issue/execution pipeline according to embodiments of the invention.

FIG. 8B is a block diagram illustrating both an exemplary embodiment of an in-order architecture core and an exemplary register renaming, out-of-order issue/execution architecture core to be included in a processor according to embodiments of the invention.

FIGS. 9A-B illustrate a block diagram of a more specific exemplary in-order core architecture, which core would be one of several logic blocks (including other cores of the same type and/or different types) in a chip.

FIG. 10 is a block diagram of a processor that may have more than one core, may have an integrated memory controller, and may have integrated graphics according to embodiments of the invention.

FIG. 11 shown is a block diagram of a system in accordance with one embodiment of the present invention.

FIG. 12 shown is a block diagram of a first more specific exemplary system in accordance with an embodiment of the present invention.

FIG. 13 shown is a block diagram of a second more specific exemplary system in accordance with an embodiment of the present invention.

FIG. 14 shown is a block diagram of a SoC in accordance with an embodiment of the present invention.

FIG. 15 is a block diagram contrasting the use of a software instruction converter to convert binary instructions in a source instruction set to binary instructions in a target instruction set according to embodiments of the invention.

### DETAILED DESCRIPTION

Disclosed herein are structure access instructions, processors to execute or process the structure access instructions, methods performed by the processors when processing or executing the structure access instructions, and systems incorporating one or more processors to process or execute the structure access instructions. In the following description, numerous specific details are set forth (e.g., specific processor configurations, sequences of operations, instruction formats, data formats, microarchitectural details, etc.). However, embodiments may be practiced without these specific details. In other instances, well-known circuits, structures and techniques have not been shown in detail to avoid obscuring the understanding of the description.

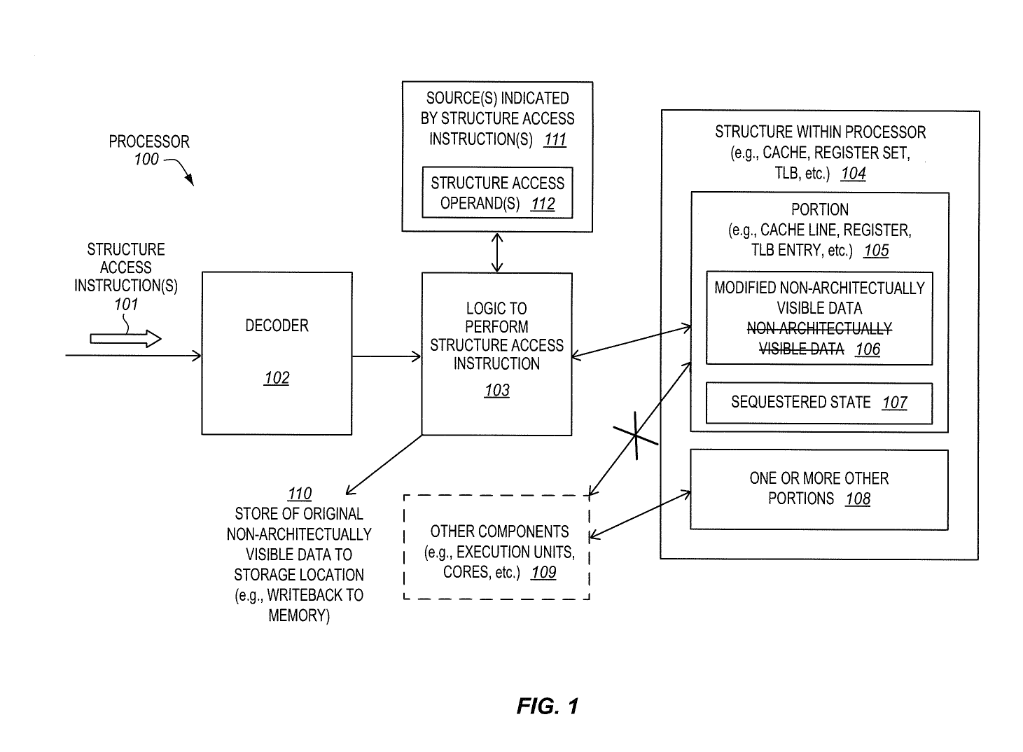

FIG. 1 is a block diagram of an embodiment of a processor 100 having an embodiment of logic 103 to perform a structure access operation responsive to an embodiment of a structure access instruction 101. The processor may be any of various complex instruction set computing (CISC) processors, various reduced instruction set computing (RISC) processors, various very long instruction word (VLIW) processors, various hybrids thereof, or other types of processors entirely. In some embodiments, the processor may be a general-purpose processor (e.g., a general-purpose microprocessor of the type used in desktop, laptop, and like computers). Alternatively, the processor may be a special-purpose processor. Examples of suitable special-purpose processors include, but are not limited to, network processors, communications processors, cryptographic processors, graphics processors, co-processors, embedded processors, digital signal processors (DSPs), and controllers (e.g., microcontrollers), to name just a few examples.

The processor may receive the one or more structure access instructions 101. For example, the instructions may be received from an instruction fetch unit, an instruction queue, or a memory. The structure access instructions may each represent a machine instruction, macroinstruction, or control signal that is recognized by the processor and that controls the apparatus to perform a particular operation. In some embodiments, each of the structure access instructions may explicitly specify (e.g., through bits or one or more fields) or otherwise indicate (e.g., implicitly indicate) one or more sources 111 (e.g., registers). Each of the sources may have a structure access operand 112. The structure access operands may provide information to specify or qualify the type of operation the logic 103 is to perform in response to the structure access instructions. Software may write data into the sources of the operands prior to carrying out the structure access instructions. In some embodiments, the instruction may explicitly specify or otherwise indicate a destination where data read from a structure is to be stored. In some cases, the sources 111 may be reused as the destinations.

The illustrated processor includes an instruction decode unit or decoder 102. The decoder may receive and decode higher-level machine instructions or macroinstructions, and output one or more lower-level micro-operations, micro-code entry points, microinstructions, or other lower-level instructions or control signals that reflect and/or are derived from the original higher-level instruction. The one or more lower-level instructions or control signals may implement the operation of the higher-level instruction through one or more lower-level (e.g., circuit-level or hardware-level) operations. The decoder may be implemented using various different mechanisms including, but not limited to, microcode read only memories (ROMs), look-up tables, hardware implementations, programmable logic arrays (PLAs), and other mechanisms used to implement decoders known in the art.

In other embodiments, instead of having the decoder 102, an instruction emulator, translator, morpher, interpreter, or other instruction conversion logic may be used. Various different types of instruction conversion logic are known in the arts and may be implemented in software, hardware, firmware, or a combination thereof. The instruction conversion logic may receive the instruction, emulate, translate, morph, interpret, or otherwise convert the received instruction into one or more corresponding derived instructions or control signals. In still other embodiments, both instruction conversion logic and a decoder may be used. For example, the apparatus may have instruction conversion logic to convert the received instruction into one or more intermediate instructions, and a decoder to decode the one or more intermediate instructions into one or more lower-level instructions or control signals executable by native hardware of the processor. Some or all of the instruction conversion logic may be located off-die from the rest of the processor, such as on a separate die or in an off-die memory.

Referring again to FIG. 1, the logic to perform the structure access operation 103 for the structure access instruction 101 is coupled with the decoder 102. The logic 103 may receive from the decoder one or more micro-operations, micro-code entry points, microinstructions, other instructions, or other control signals, which reflect, or are derived from, the one or more structure access instructions. The logic 103 is also coupled with the one or more sources (e.g., one or more registers or other storage locations) indicated by the one or more structure access instructions. As previously mentioned, the sources may have structure access operands that help to specify or qualify the operation the logic 103is to perform responsive to the structure access instructions. Specific examples of operands will be discussed further below.

The logic 103 is also coupled with a structure 104 of the processor. By way of example, the structure may be a cache, a register set, a translation lookaside buffer (TLB), another type of cache or buffer, an address decoder, a micro-architectural structure of the processor, or the like. The structure has a portion 105, and one or more other portions 108. By way of example, in the case of the structure being a cache, the portion 105 may be an individual cache line, and the other portions 108 may be all of the other cache lines. As another example, in the case of the structure being a register set, the portion 105 may be an individual register, and the other portions 108 may be all of the other registers. As yet another example, in the case of the structure being a TLB, the portion 105 may be an individual entry of the TLB, and the other portions 108 may be all of the other entries of the TLB. These are just a few illustrative examples of suitable structures and portions.

The logic 103 is operable, in response to and/or as a result of the one or more structure access instructions 101 to change a state of the portion 105 of the structure 104 to a sequestered state 107. In some embodiments, a first structure access instruction may cause the logic 103 to change the state. In the sequestered state, the logic 103, while processing the one or more structure access instructions 101, is able to access the portion 105 of the structure, as well as the other portions 108 of the structure. However, in the sequestered state, other components 109 of the processor (e.g., other logic and cores not processing the structure access instructions 101) are not able to access the portion 105 of the structure (as indicated in the illustration by the “X” through the bi-directional arrow), but are able to access one or more other portions 108 of the structure. Sequestering the portion 105 of the structure may effectively disable the portion of the structure to all but the resources executing or carrying out the structure access instructions and/or effectively render the portion unusable to these other components.

Sequestering the portion effectively makes the portion unavailable to the other components so that data in the portion may be modified without interference from the other components and without the other components accessing the data prior to the modification being completed. By way of example, in the case of a cache and a cache line, the other components 109 will not check the sequestered cache line 105 for hits and will not store or retrieve data from the sequestered cache line 105, although the cache is still up and running and the other components 109 may store or read data from the other non-sequestered cache lines 108 of the cache. As another example, in the case of a register set and a register, the other components 109 will not access the sequestered register 105, although the sequestered register set is still up and running and the other components 109 may store or read data from the other non-sequestered registers 108 of the register set. In some embodiments, renaming, remapping, or the like, may be performed for sequestered registers or other sequestered portions when the micro-architectural structure has an architectural meaning. For example, register Ax and other architectural registers may be renamed or remapped to another un-sequestered register. As an example, this may be achieved with the use of a re-order buffer.

By way of example, changing the portion of the structure to the sequestered state may include setting one or more bits associated with the portion (e.g., setting one or more per-cache line bits in the case of a cache, setting one or more per-register bits in the case of a register set, setting one or more per-entry bits in a TLB, etc.). In some embodiments, when the structure has original/initial data, the logic 103, responsive to the one or more structure access instructions (e.g., to the first structure access instruction), may coherently store the original non-architecturally visible data to an appropriate storage location 110, prior to modifying the non-architecturally visible data, so that the original/initial data is not lost. For example, in the case of a cache, the original data may be written back to memory.

Referring again to the illustration, the logic 103 is further operable, in response to and/or as a result of the one or more structure access instructions 101 to modify original non-architecturally visible data in the portion of the structure to modified non-architecturally visible data 106, while the portion of the structure is in the sequestered state. In some embodiments, a second structure access instruction may cause the logic 103 to modify the data. In some embodiments, two or more structure access instructions may be used to make two or more sequential modifications. As used herein, modifying includes changing one or more bits (e.g., either by directly changing the one or more individual bits, or by replacing an entire data value with another data value having one or more bits that are different).

By way of example, in the case of the structure 104 being a cache and the portion 105 being a cache line, the logic 103 may modify one or more fields, values, or portions of the cache line. Examples of fields, values, or portions of the cache line that may be modified include, but are not limited to, tags, error correction or parity data, state, cache replacement data, and the actual data, and combinations thereof. The error correction data may be based on various different error correction schemes. Similarly, the cache replacement data may be based on various different schemes (e.g., least recently used (LRU), pseudo LRU, most recently used, etc.). By way of example, the logic 103, responsive to the one or more structure access instructions, may flip one or more bits in a tag or error correction field of a cache line, or replace the tag or error correction field with another different incorrect value (e.g., to introduce an error).

Significantly, in some embodiments, the structure access instructions disclosed herein may help to provide access (e.g., read and/or write access) to what are otherwise typically non-architecturally visible or micro-architectural fields, data, or portions of either architecturally visible structures (e.g., register sets, etc.) or non-architecturally visible structures (e.g., caches, TLBs, etc.). The non-architecturally visible or micro-architectural fields, data, or portions of these structures may represent resources that application programs are typically not aware of. For example, in the case of caches, the application programs typically do not need to be aware of the presence of the caches, let alone be aware of the tag values, error correction data, cache replacement data, or other non-architecturally visible data or fields of the caches. Without the structure access instructions disclosed herein, these non-architecturally visible or micro-architectural fields, data, or portions of structures are generally otherwise unavailable to programs (e.g., unavailable to general-purpose macroinstructions).

Accessing these non-architecturally visible or micro-architectural fields, data, or portions of the structures with the structure access instructions disclosed herein may be used for various different purposes. By way of example, the accesses may be used to help manage, monitor, test, control, reconfigure, or otherwise interact with the structures. As one particular example, the structure access instructions may be used to inject errors into a structure (e.g., a cache, register set, other data storing structure, etc.). For example, a tag, error correction, cache replacement, or other field of a cache line may be corrupted (e.g., one or more of the bits may be flipped). As an example, this may be performed in order to test the ability of the cache to detect and/or correct the error. In other embodiments, the instructions disclosed herein may be used to perform on-the-fly (e.g., during runtime or active execution) reconfiguration of a structure. For example, the structure access instructions may be used to disable defective cache lines or other portions of structures during runtime.

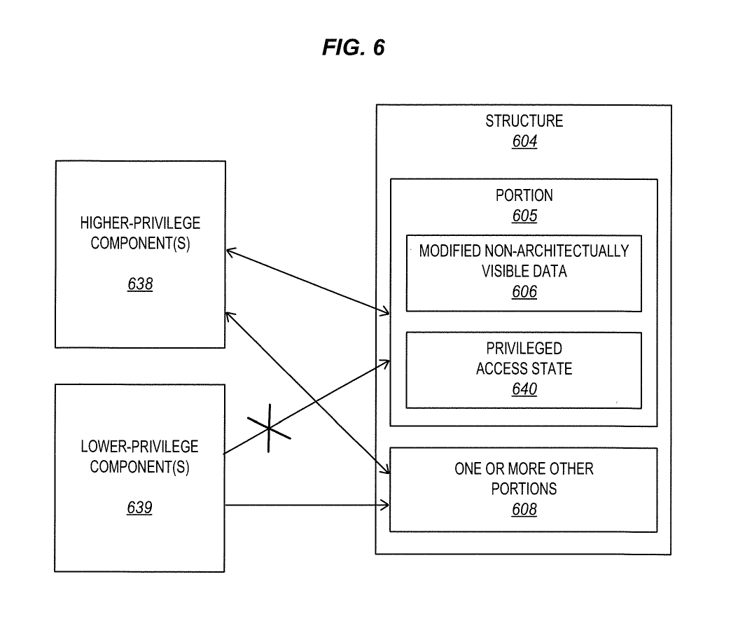

Referring again to the illustration, the logic 103 is further operable, in response to and/or as a result of the one or more structure access instructions 101 to change the state of the portion of the structure from the sequestered state to a non-sequestered state (not shown) after modifying the non-architecturally visible data in the portion of the structure. In some embodiments, a third structure access instruction may cause the logic 103 to change the state to the non-sequestered state. By way of example, in the case of a cache, the non-sequestered state may be a MESI state (e.g., a modified, exclusive, shared, or invalid state). In some embodiments, this may allow the other components 109 to be able to access the portion 105 and/or the modified non-architecturally visible data 106. Alternatively, as will be explained further below, in some embodiment, an additional privileged access state may be configured which may allow higher-privileged components but not lower-privileged components access to the portion 105 (see e.g., FIG. 6).

Advantageously, the modification of the data in the portion of the structure may be made pseudo-atomically. The other components may not be able to access the portion of the structure or the data therein, but are able to remain in operation and are able to access the other portions of the structure. The pseudo atomic operation helps to perform a modification of the data atomically without interference from other components in the system. The pseudo atomic operation may effectively make the portion of the structure being modified temporarily inaccessible to the other components. If the other components were able to access the data in the portion, they could potentially use the data, which could lead to errors, or they could potentially modify the data, which may not be desired. For example, in the case of modifying a cache line, the pseudo-atomic modification may help to prevent another component from evicting or further modifying the cache line prior to the modification being completed. It may also help to prevent another component from accessing modified data in the cache line prior to the modification being completed, which could potentially lead to errors.

Moreover, the modification may be made without needing to quiesce the entire structure and/or without needing to quiesce the other components that are able to access the structure. Quiescing the entire structure and/or quiescing the other components that are able to access the structure may also help to prevent interference from these other components. However, quiescing the entire structure and/or quiescing the other components generally tends to reduce performance. For example, quiescing the other components (e.g., execution units, other cores in a multi-core system, other processors in a multi-processor system, etc.) typically involves stopping or pausing the execution of these components, which reduces performance. Likewise, quiescing entire caches, entire register sets, and the like, also tends to reduce performance.

The logic 103 may include logic that is responsive to the structure access instructions to perform the structure access operations. The particular logic may vary depending upon the structure being operated on and/or targeted by the structure access instruction. Commonly, the logic may include native circuitry or other logic associated with the structure and/or part of the structure which is used to manipulate the structure (e.g., add and/or modify non-architecturally visible data within these structures). By way of example, in the case of a cache, TLB, or memory related structure, the logic may be part of one of these structures and/or associated logic that manipulates these structures (e.g., integrated circuitry that accesses error correction data, tags, etc.). As another example, in the case of a register file, the logic 103 may be part of an execution unit that accesses architecturally-visible data in the register file and/or part of the register file. The logic 103 and/or the apparatus may include specific or particular logic (e.g., circuitry or other hardware potentially combined with software and/or firmware) operable to perform the operations of the structure access instruction in response to the structure access instruction (e.g., in response to one or more microinstructions or other control signals derived from the instruction).

To avoid obscuring the description, a relatively simple processor 100 has been shown and described. In other embodiments, the processor may optionally include other well-known components, such as, for example, an instruction fetch unit, an instruction scheduling unit, a branch prediction unit, instruction and data caches, instruction and data translation lookaside buffers, prefetch buffers, microinstruction queues, microinstruction sequencers, bus interface units, second or higher level caches, a retirement unit, a register renaming unit, other components included in processors, and various combinations thereof. Embodiments may have multiple cores, logical processors, or execution engines. Logic operable to carry out or execute an embodiment of an instruction disclosed herein may be included in at least one, at least two, most, or all of the cores, logical processors, or execution engines. There are literally numerous different combinations and configurations of components in processors, and embodiments are not limited to any particular combination or configuration.

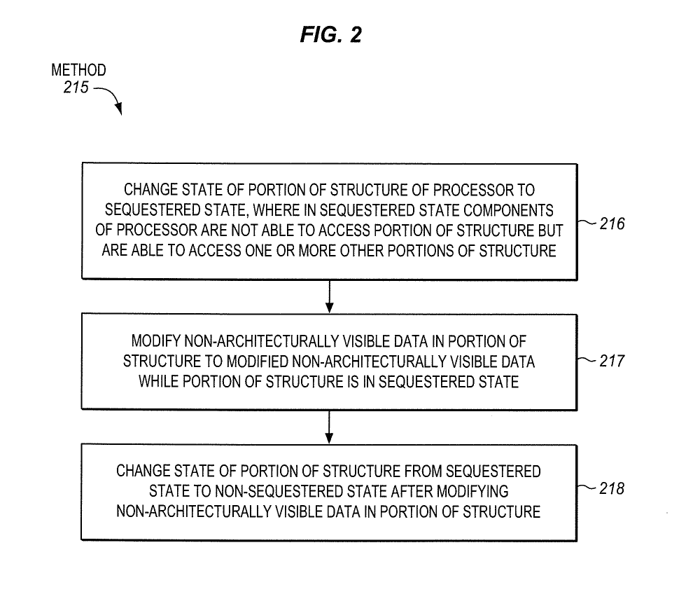

FIG. 2 is a block flow diagram of an example embodiment of a method 215 that may be performed in response to embodiments of one or more structure access instructions. In various embodiments, the method may be performed by a general-purpose processor, a special-purpose processor (e.g., a network processor, graphics processor, or a digital signal processor), or another type of digital logic device. In various aspects, the instructions may be received at a processor or a portion thereof (e.g., a decoder, instruction converter, etc.). In various aspects, the instruction may be received from an off-processor source (e.g., from a main memory, a disc, or a bus or interconnect), or from an on-processor source (e.g., from an instruction cache). In some embodiments, the method 215 may be performed by the processor 100 of FIG. 1, or a similar processor. Alternatively, the method may be performed by different embodiments of processors. Moreover, the processor 100 may perform embodiments of operations and methods either the same as, similar to, or different than those of the method 215.

The method includes changing a state of a portion of a structure of a processor to a sequestered state, at block 216. In the sequestered state components of the processor are not able to access the portion of the structure, but are able to access one or more other portions of the structure. In some embodiments, original/initial data in the portion of the structure may be coherently written or stored to another storage location. In some embodiments, this operation may be performed in response to a first structure access instruction.

Non-architecturally visible data in the portion of the structure is modified to modified non-architecturally visible data, while the portion of the structure is in the sequestered state, at block 217. By way of example, in the case of the structure being a cache and the portion being a cache line, processor logic responsive to the instruction may modify one or more of a tag, error correction or parity data, state, cache replacement data, and actual data of the cache line. In some embodiments, this operation may be performed in response to a second structure access instruction. In some embodiments, one or more additional structure access instructions may be used to make one or more additional, sequential modifications to the portion of the structure while it is in the sequestered state. Advantageously, the one or more structure access instructions may provide read and/or write access to non-architecturally visible or micro-architectural fields, data, or portions of a structure that are otherwise typically unavailable to macroinstructions and/or machine instructions.

The state of the portion of the structure is changed from the sequestered state to a non-sequestered state, after modifying the non-architecturally visible data in the portion of the structure, at block 218. Advantageously, the modification of the data in the portion of the structure may be made pseudo-atomically. The other components may not be able to access the portion of the structure or the data therein so that they don't interfere, but are able to remain in operation and are able to access the other portions of the structure. Quiescing the other components or the entire structure is not required.

The method has been shown and described in a basic form, although operations may optionally be added to and/or removed from the method. By way of example, the structure access instruction may be fetched, decoded (or otherwise converted) into one or more other instructions or control signals, logic may be enabled to perform the operations of the instruction, the logic may perform the operations, etc. In addition, a particular order of the operations may have been shown and/or described, although alternate embodiments may perform certain operations in different order, combine certain operations, overlap certain operations, etc. For example, in an alternate embodiment, the modification may be performed concurrently, or at least partially concurrently, with the changing of the state to the sequestered state.

To further illustrate certain concepts, it may be helpful to consider an example cache, and an example of sequestering a cache line and modifying the cache line prior to changing the cache line to a non-sequestered state. As is known, caches are structures commonly found in processors that are used to transparently store data so that the data may be accessed more quickly than if the data was in another storage location (e.g., an off-processor memory). The data stored within the cache may represent copies of stored in the other storage location. The cache structure is typically arranged into a number of entries. Each of the entries has corresponding data. Each of the entries also typically has a tag that is used to identify the data in the entry (e.g., determine whether the data in the entry corresponds to the desired data in the other storage location).

When a processing unit, core, or other entity wants to access a given data in the other storage location, it may first check the cache to determine whether or not the desired data is present in the cache. The entity may examine the tags to determine whether or not they correspond to the desired data. If the data is in the cache (e.g., there is a cache hit), then the data may be retrieved from the cache. This may help to avoid a slower access to the data in the other storage location (e.g., an off-processor memory). Otherwise, if no entry is found with a tag matching that of the desired data (e.g., there is a cache miss), then the data may be accessed from the other storage location (e.g., from an off-processor memory), which generally tends to be a slower access. Generally the higher the percentage of cache accesses that are cache hits, the faster overall system performance.

Commonly, during a cache miss, the processor may evict another entry of the cache to make room for the newly retrieved data from the other storage location. The entry that is to be evicted may be selected according to an algorithm based on a given replacement policy. Various replacement policies are known in the art. Examples of replacement policies include, but are not limited to, least recently used (LRU), most recently used (MRU), and pseudo LRU, random replacement, etc. Each entry of the cache may also include cache replacement data (e.g., one or more LRU bits) which may be used by the cache replacement algorithm.

Each entry of the cache also typically includes state or coherency data that is used to maintain coherency of the data in a coherency domain (e.g., generally including at least the cache and the off-processor backing storage location). A common coherency protocol used in caches is the MESI (modified-exclusive-shared-invalid) protocol, as well as other protocols derived from or similar to the MESI protocol. In the MESI protocol, each entry of the cache or each cache line is indicated to be in one of the four states modified, exclusive, shared, and invalid. These states are well known in the art. Other protocols may define other or related states.

Commonly, an error correction scheme is also employed in caches to help correct certain levels of errors. Each entry of the cache may include error correction data (e.g., one or more bits of error correction code). The one or more bits of error correction code may represent parity bits or redundant data that may be used to correct errors in other fields (e.g., detect and correct an error representing an erroneous flip of a bit in the data). Various different error correction schemes are known in the art, such as, for example, those based on Hamming codes. In some embodiments, multiple or each of the fields of the cache line (e.g., data, tag, state, cache replacement, use vector, valid, etc., may have their own corresponding error correction data.

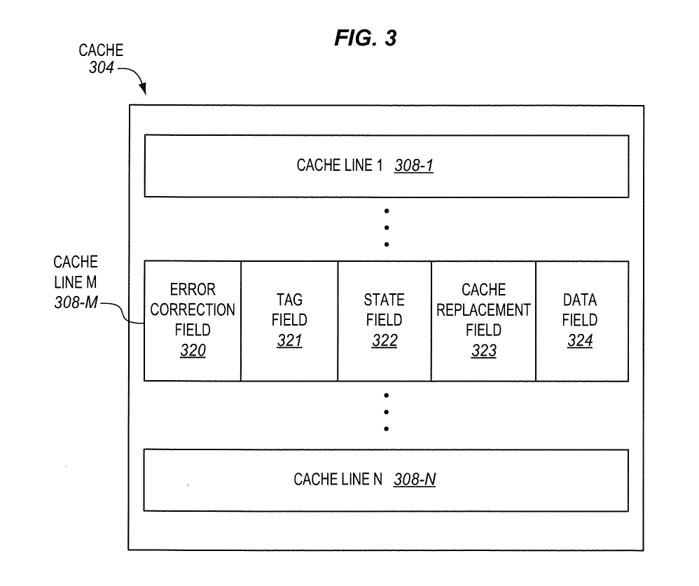

FIG. 3 is a block diagram of an example embodiment of a cache 304. The cache includes a number N of cache lines 308-1 through 308-N. In some embodiments, a structure access instruction may operate on an individual cache line. For example, as shown in the illustration, the structure access instruction may operate on a cache line M 308-M. The structure access instruction may specify or otherwise indicate the cache line M. In some embodiments, in which the structure access instruction is able to operate on multiple different structures (e.g., multiple levels of cache), or multiple different types of structures, the structure access instruction may specify or otherwise indicate the cache.

The illustrated cache line M includes a number of cache line fields or portions including an error correction field 320, a tag field 321, a state field 322, a cache replacement field 323, and a data field 324. In some embodiments, any one or more of these fields of the cache line may be sequestered, modified, and then un-sequestered by one or more structure access instructions. In some embodiments, the error correction field (e.g., one or more error correcting code bits) may be changed.

In some embodiments, the tag field may be changed. In some embodiments, the state field (e.g., a MESI state) may be changed. In some embodiments, the cache replacement field (e.g., one or more LRU, pseudo LRU, or MRU bits) may be changed. In some embodiments, the data may be changed. The data may be modified to either valid or invalid data. In some embodiments, after the modification, the cache line M may be changed to a non-sequestered state selected from a modified state, an exclusive state, a shared state, and an invalid state.

In some embodiments, the structure access instruction may indicate either that the cache is, or is not, to apply error correction (e.g., generate error correction code) for the modified data. The cache typically has circuitry that automatically generates error correction code when data is written to the cache lines. The structure access instruction may either specify that this automatic updating is to be performed (e.g., to save the effort of having to automatically generate the appropriate error correction code), or may disable this automatic updating (e.g., to perform diagnosis or testing). In other words, if a field (e.g., a data field) has a dependency on another field (e.g., an error correction or parity field), the instruction may either specify that the dependent one is to be updated when the other one is changed, or that the dependent one is not to be updated when the other one is changed such that there may be some inconsistency. In some embodiments, the structure access instruction may replace data and also replace error correction data for that data.

This is just one example of a suitable structure. Another example of a suitable structure is a register set or group of registers. Processors commonly include one or more register sets (e.g., sets or groups of registers). The registers of the register set generally represent architecturally-visible registers. The architecturally-visible registers typically represent on-die processor storage locations. The architecturally-visible registers may also be referred to herein as architectural registers or simply as registers. The processor may include various types of register sets. A few examples of different types of register sets include, but are not limited to, general-purpose register sets, scalar register sets, packed data register sets, floating point register sets, and status and control registers. In some cases, registers may be used for multiple types of data (e.g., integer and floating point data). While the data in the registers specified by the instructions is architecturally-visible, the registers typically also include non-architecturally visible or micro-architectural fields or portions. By way of example, the registers often include protection bits or error correction data. As another example, the registers may include scoreboard bits or data, which may indicate that the register contents are ‘in flight’ and not yet available for access. In some embodiments, non-architecturally visible fields or portions of registers (e.g., protection bits) may be sequestered, modified, and then un-sequestered by one or more structure access instructions as disclosed herein.

Yet another example of a suitable structure is translation lookaside buffer (TLB). Processors commonly include one or more TLBs to buffer or cache virtual to physical address translations. The TLBs are commonly arranged as a number of entries where each entry stores a given virtual to physical address translation. In some embodiments, non-architecturally visible fields or portions of entries of a TLB may be sequestered, modified, and then un-sequestered by one or more structure access instructions as disclosed herein. Examples of such non-architecturally visible fields include, but are not limited to, page masks, page sizes, error correction data, parity data, access rights data, pre-validation bits or data, virtual addresses, physical addresses, dirty bits, pin bits, and the like.

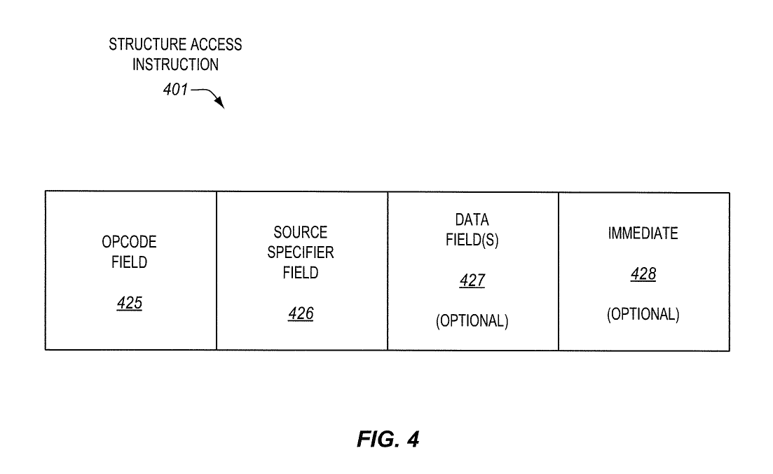

FIG. 4 is a block diagram of an embodiment of a structure access instruction 401. The structure access instruction includes an operation code or opcode field 425. The opcode field may represent a plurality of bits, or one or more fields, that are operable to identify the instruction and/or at least partly identify the operation to be performed.

The illustrated embodiment of the structure access instruction also includes a source specifier field 426. The source specifier field is operable to explicitly specify a source operand (e.g., a source register or other source storage location). By way of example, the source specifier may include an address of a general-purpose register. Alternatively, rather than having a source specifier to explicitly specify the source, the source may be implicit or inherent to the instruction. In some alternate embodiments, two or more sources may either be explicitly specified or implicitly indicated by the instruction. The one or more sources may help along with the opcode to specify or qualify the type of operation that is to be performed responsive to the structure access instruction. In some embodiments, the instruction may further have a destination specifier (e.g., to specify a destination where read out data is to be stored). Alternatively, the source may be reused as the destination.

The illustrated embodiment of the structure access instruction also optionally includes one or more data fields 427 and an optional immediate 428. Either or both of these fields may optionally be included to further help to specify or qualify the type of operation that is to be performed responsive to the structure access instruction.

The illustrated instruction format shows examples of the types of fields that may be included in an embodiment structure access instruction. In general, one or more of the source specifier, data, and immediate fields may be included to either alone or in combination help to specify or qualify the type of operation that is to be performed responsive to the structure access instruction. Alternate embodiments may include a subset of the illustrated fields, may add additional fields, may include different fields, or a combination thereof. Moreover, the illustrated order/arrangement of the fields is not required, but rather the fields may be rearranged. Fields need not include contiguous sequences of bits but rather may be composed of non-contiguous or separated bits.

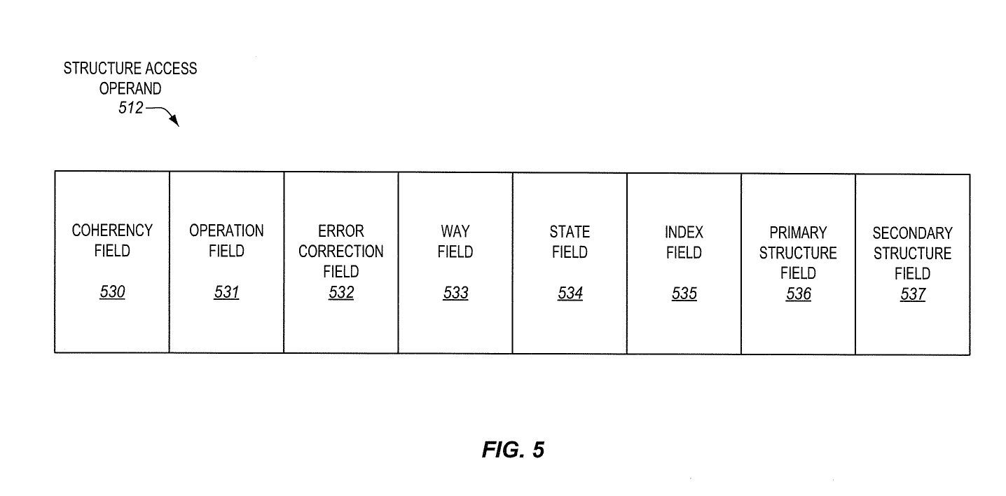

FIG. 5 is a block diagram of an embodiment of a structure access operand 512. In some embodiments, the structure access operand may be provided by a source (e.g., a source register) specified or otherwise indicated by a structure access instruction. The illustrated embodiment of the operand includes a coherency field 530, an operation field 531, an error correction field 532, a way field 533, a state field 534, an index field 535, a primary structure field 536, and a secondary structure field 537. Other embodiments may include fewer, more, or different fields.

The coherency field 530 may indicate whether or not the operation should maintain data coherency. For example, the coherency field may indicate whether or not original/initial data in the portion of the structure being accessed should be stored in another storage location if it is going to be modified so that the original/initial data is not lost. By way of example, in the case of a cache line, the coherency field may indicate whether or not the cache line is to be written back to memory prior to the modification.

The operation field 531 may represent a structure specific encoding that at least partially specifies the operation to be performed on a given structure. By way of example, in the case of the structure being a cache, a three bit operation field of an example embodiment of a structure access instruction may have a value of ‘x00’ to indicate that the operation is a diagnose operation to read a tag into a destination, may have a value of ‘x10’ to indicate that the operation is a diagnose operation to write a tag into a cache line from a source, may have a value of ‘x11’ to indicate that the operation is a diagnose operation to read a state into a destination, have a value of '001 to indicate that the operation is a diagnose operation to purge a value, or may have a value of '101 to indicate that the operation is a coherent writeback with a state change to an invalid or sequestered state. These are just a few illustrative examples specific to caches. Fewer or more bits may be included to specify fewer or more different types of operations including operations pertinent to other types of structures as disclosed elsewhere herein.

The error correction field 532 may indicate whether or not the processor is to generate new error correction data/bits as a result of the modification. By way of example, a single bit may have a value of 1 to indicate that the processor is to generate new error correction data or parity bits, or a value of 0 to indicate that the processor is not to generate new error correction data or parity bits. This field may be omitted or ignored when the structure does not perform error correction.

The way field 533 may specify a desired way to operate on. This field may be omitted or ignored when the structure is not a cache.

The state field 534 may indicate the state of the portion of the structure after the structure access instruction has executed or carried out. In some embodiments, the state may indicate sequestered or non-sequestered. As one example, the state field may include a single bit that has a value of 1 to indicate a sequestered state or a value of 0 to indicate a non-sequestered state. In other examples, additional bits may be included to indicate other states (e.g. MESI states in the case of caches).

The index field 535 may indicate the index to operate on. The number of bits and the meaning of the index field may be structure specific. This field may be omitted or ignored when the structure does not have an index.

The primary structure field 536 may indicate the structure that the structure access instruction is to operate on. In some embodiments, the structure access instruction may be operable to operate on a given type of structure. For example, the structure access instruction (e.g., an opcode) may be specific to caches, and the primary structure field may indicate a particular one of a multiple different caches (e.g., a mid-level cache, a lowest level cache, etc.). In one example, a single bit may be provided to indicate either the mid-level cache or a lowest level cache. As another example, multiple levels of TLB may be indicated. If desired, multiple different types of structure access instructions (e.g., different opcodes) may be included for different types of structures. Alternatively, in other embodiments, the given structure access instruction (e.g., an opcode) may be able to operate on different types of structures, and the primary structure field may indicate the particular structure from among different types of structures (e.g., caches, register sets, TLBs, or other structures) and may indicate the particular level of the structure if multiple levels exist (e.g., indicate the particular level of cache or TLB if multiple levels exist). The number of bits of the primary structure field may vary depending upon the number of structures selected among.

The secondary structure field 537 may indicate the particular portion of the structure indicated by the primary structure field that is to be operated on. For example, in embodiments in which the structure is a cache, the secondary structure field may have different values to indicate that the portion is a data field of a cache line, a tag field of a cache line, a state field of a cache line, or an error correction field of the cache line. In some embodiments, different instances of structure access instructions may be used to modify multiple of these different fields. Alternatively, a single structure access instruction may be capable of specifying multiple fields to be changed within the single instruction.

The illustrated structure access operand represents a particular detailed example of a suitable operand showing the types of fields that may be included in an embodiment of structure access operand. Alternate embodiments may have fewer, more, or different fields, or a combination thereof. Moreover, some or all of these fields may be moved from the operand to data or immediate fields embedded in the instruction encoding. The combination of the instruction encoding and the structure access operand may fully indicate the type of operation to be performed. Furthermore, in alternate embodiments, some of the information that was described above as being explicitly specified may instead be implicit or inherent to the instruction rather than being explicitly specified. The illustrated order/arrangement of the fields is not required, but rather the fields may be rearranged. Fields need not include contiguous sequences of bits but rather may be composed of non-contiguous or separated bits.

In some embodiments, use of the structure access instructions disclosed herein to modify data may be restricted to certain components, such as relatively higher-privilege components, although this is not required. Examples of suitable higher-privilege components include, but are not limited to, operating systems, hypervisors, virtual machine monitors, and other relatively higher privilege software or components having higher privileges than relatively lower-privilege components (e.g., user level application programs). The higher-privilege components have relatively higher privileges than the lower-privilege components. These are relative terms.

Moreover, in some embodiments, a processor and/or a structure thereof may have an additional privileged access state. The privileged access state is different than a sequestered state. The privileged access state may be entered after a sequestered modification of data as discussed above. The privileged access state may permit only higher-privilege components to have access to the portion of the structure in the privileged access state and prevent lower-privilege components from accessing the portion of the structure in the privileged access state.

FIG. 6 is a block diagram of an embodiment of a structure 604 having a privileged access state 640 that allows higher-privilege component(s) 638 to access a portion 605 of the structure and prevents lower-privilege components 639 from accessing the portion 605 of the structure. By way of example, in the case of a cache, the privileged access state may represent one or more per-cache line bits to designate whether or not the corresponding cache line is in the privileged access state. By way of example, after the portion of the structure has been modified, while in the sequestered state, a structure access instruction may be used to change the state of the portion of the structure to the privileged visibility state. When in the privileged visibility state, only the higher-privilege components may be able to access the portion and/or modified non-architecturally visible data 606, but the lower-privilege components may not be able to access the portion and/or the modified non-architecturally visible data. Both the higher-privileged components and the lower-privileged components may be permitted to access one or more other portions 608 of the structure.

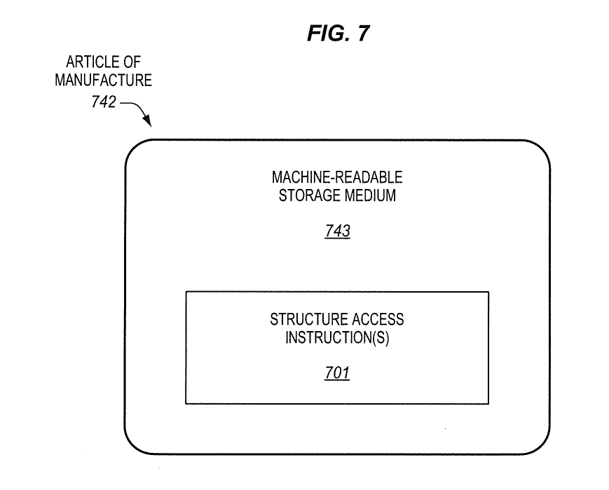

FIG. 7 is a block diagram of an article of manufacture (e.g., a computer program product) 742 including a machine-readable storage medium 743. In some embodiments, the machine-readable storage medium may be a tangible and/or non-transitory machine-readable storage medium. In various example embodiments, the machine-readable storage medium may include a floppy diskette, an optical disk, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a semiconductor memory, other types of memory, or a combinations thereof. In some embodiments, the medium may include one or more solid data storage materials, such as, for example, a semiconductor data storage material, a phase-change data storage material, a magnetic data storage material, an optically transparent solid data storage material, etc.

The machine-readable storage medium stores one or more structure access instructions 701. The one or more structure access instructions, if executed or carried out by a machine, are operable to cause the machine to perform one or more operations or methods as disclosed herein. Examples of different types of machines include, but are not limited to, processors (e.g., general-purpose processors and special-purpose processors), instruction processing apparatus, and various electronic devices having one or more processors and/or that execute or process instructions. A few representative examples of such machines or electronic devices include, but are not limited to, computer systems, desktops, laptops, notebooks, servers, network routers, network switches, nettops, set-top boxes, cellular phones, video game controllers, etc.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

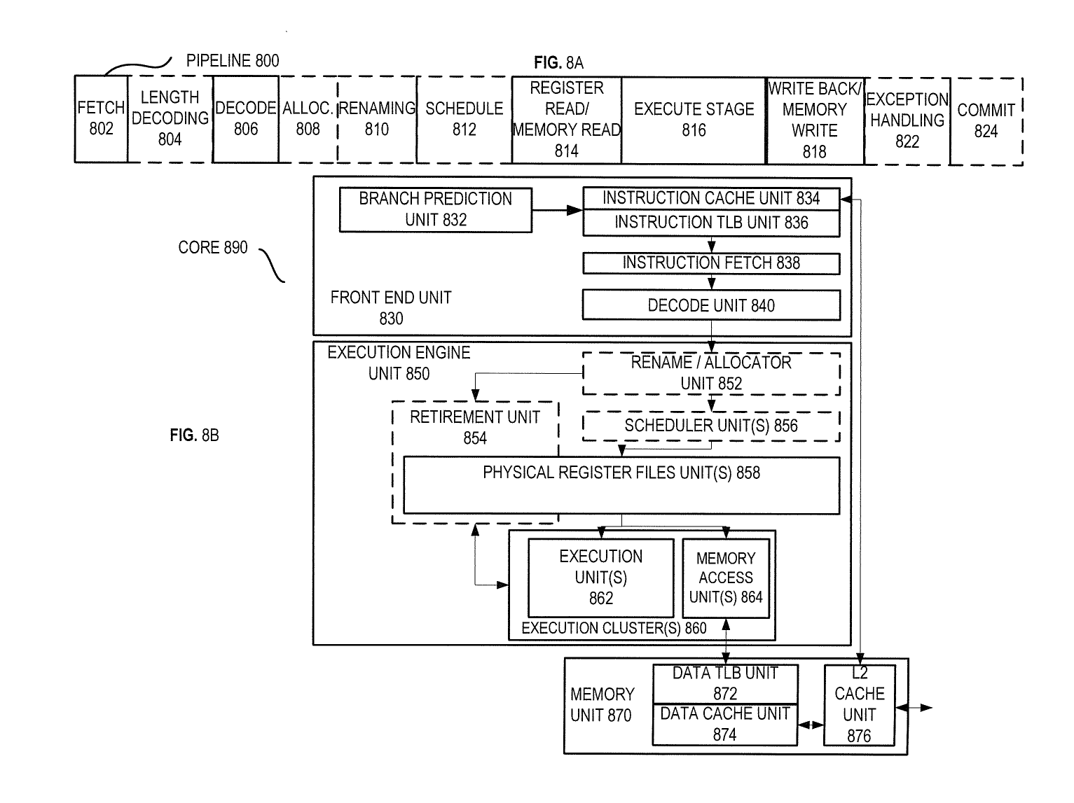

FIG. 8A is a block diagram illustrating both an exemplary in-order pipeline and an exemplary register renaming, out-of-order issue/execution pipeline according to embodiments of the invention. FIG. 8B is a block diagram illustrating both an exemplary embodiment of an in-order architecture core and an exemplary register renaming, out-of-order issue/execution architecture core to be included in a processor according to embodiments of the invention. The solid lined boxes in FIGS. 8A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8A, a processor pipeline 800 includes a fetch stage 802, a length decode stage 804, a decode stage 806, an allocation stage 808, a renaming stage 810, a scheduling (also known as a dispatch or issue) stage 812, a register read/memory read stage 814, an execute stage 816, a write back/memory write stage 818, an exception handling stage 822, and a commit stage 824.

FIG. 8B shows processor core 890 including a front end unit 830 coupled to an execution engine unit 850, and both are coupled to a memory unit 870. The core 890 may be a reduced instruction set computing (RISC) core, a complex instruction set computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front end unit 830 includes a branch prediction unit 832 coupled to an instruction cache unit 834, which is coupled to an instruction translation lookaside buffer (TLB) 836, which is coupled to an instruction fetch unit 838, which is coupled to a decode unit 840. The decode unit 840 (or decoder) may decode instructions, and generate as an output one or more micro-operations, micro-code entry points, microinstructions, other instructions, or other control signals, which are decoded from, or which otherwise reflect, or are derived from, the original instructions. The decode unit 840 may be implemented using various different mechanisms. Examples of suitable mechanisms include, but are not limited to, look-up tables, hardware implementations, programmable logic arrays (PLAs), microcode read only memories (ROMs), etc. In one embodiment, the core 890 includes a microcode ROM or other medium that stores microcode for certain macroinstructions (e.g., in decode unit 840 or otherwise within the front end unit 830). The decode unit 840 is coupled to a rename/allocator unit 852 in the execution engine unit 850.

The execution engine unit 850 includes the rename/allocator unit 852 coupled to a retirement unit 854 and a set of one or more scheduler unit(s) 856. The scheduler unit(s) 856 represents any number of different schedulers, including reservations stations, central instruction window, etc. The scheduler unit(s) 856 is coupled to the physical register file(s) unit(s) 858. Each of the physical register file(s) units 858 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 858 comprises a vector registers unit, a write mask registers unit, and a scalar registers unit. These register units may provide architectural vector registers, vector mask registers, and general purpose registers. The physical register file(s) unit(s) 858 is overlapped by the retirement unit 854 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 854 and the physical register file(s) unit(s) 858 are coupled to the execution cluster(s) 860. The execution cluster(s) 860 includes a set of one or more execution units 862 and a set of one or more memory access units 864. The execution units 862 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 856, physical register file(s) unit(s) 858, and execution cluster(s) 860 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 864). It should also be understood that where separate pipelines are used, one or more of these pipelines may be out-of-order issue/execution and the rest in-order.

The set of memory access units 864 is coupled to the memory unit 870, which includes a data TLB unit 872 coupled to a data cache unit 874 coupled to a level 2 (L2) cache unit 876. In one exemplary embodiment, the memory access units 864 may include a load unit, a store address unit, and a store data unit, each of which is coupled to the data TLB unit 872 in the memory unit 870. The instruction cache unit 834 is further coupled to a level 2 (L2) cache unit 876 in the memory unit 870. The L2 cache unit 876 is coupled to one or more other levels of cache and eventually to a main memory.

By way of example, the exemplary register renaming, out-of-order issue/execution core architecture may implement the pipeline 800 as follows: 1) the instruction fetch 838 performs the fetch and length decoding stages 802 and 804; 2) the decode unit 840 performs the decode stage 806; 3) the rename/allocator unit 852 performs the allocation stage 808 and renaming stage 810; 4) the scheduler unit(s) 856 performs the schedule stage 812; 5) the physical register file(s) unit(s) 858 and the memory unit 870 perform the register read/memory read stage 814; the execution cluster 860 perform the execute stage 816; 6) the memory unit 870 and the physical register file(s) unit(s) 858 perform the write back/memory write stage 818; 7) various units may be involved in the exception handling stage 822; and 8) the retirement unit 854 and the physical register file(s) unit(s) 858 perform the commit stage 824.

The core 890 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 890 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 834/874 and a shared L2 cache unit 876, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific Exemplary In-Order Core Architecture

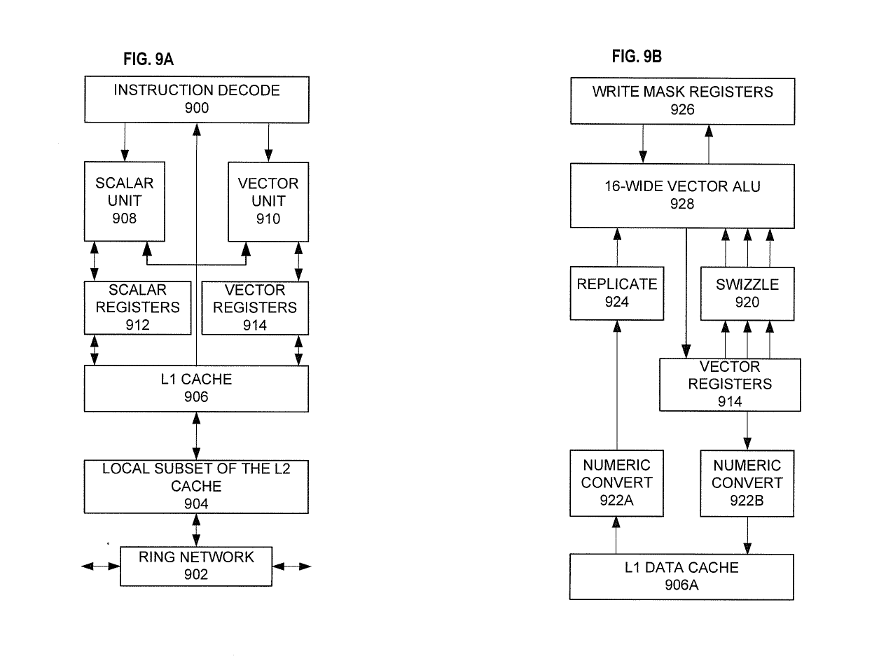

FIGS. 9A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 9A is a block diagram of a single processor core, along with its connection to the on-die interconnect network 902 and with its local subset of the Level 2 (L2) cache 904, according to embodiments of the invention. In one embodiment, an instruction decoder 900 supports the x86 instruction set with a packed data instruction set extension. An L1 cache 906 allows low-latency accesses to cache memory into the scalar and vector units. While in one embodiment (to simplify the design), a scalar unit 908 and a vector unit 910 use separate register sets (respectively, scalar registers 912 and vector registers 914) and data transferred between them is written to memory and then read back in from a level 1 (L1) cache 906, alternative embodiments of the invention may use a different approach (e.g., use a single register set or include a communication path that allow data to be transferred between the two register files without being written and read back).

The local subset of the L2 cache 904 is part of a global L2 cache that is divided into separate local subsets, one per processor core. Each processor core has a direct access path to its own local subset of the L2 cache 904. Data read by a processor core is stored in its L2 cache subset 904 and can be accessed quickly, in parallel with other processor cores accessing their own local L2 cache subsets. Data written by a processor core is stored in its own L2 cache subset 904 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 9B is an expanded view of part of the processor core in FIG. 9A according to embodiments of the invention. FIG. 9B includes an L1 data cache 906A part of the L1 cache 904, as well as more detail regarding the vector unit 910 and the vector registers 914. Specifically, the vector unit 910 is a 16-wide vector processing unit (VPU) (see the 16-wide ALU 928), which executes one or more of integer, single-precision float, and double-precision float instructions. The VPU supports swizzling the register inputs with swizzle unit 920, numeric conversion with numeric convert units 922A-B, and replication with replication unit 924 on the memory input. Write mask registers 926 allow predicating resulting vector writes.

Processor with Integrated Memory Controller and Graphics

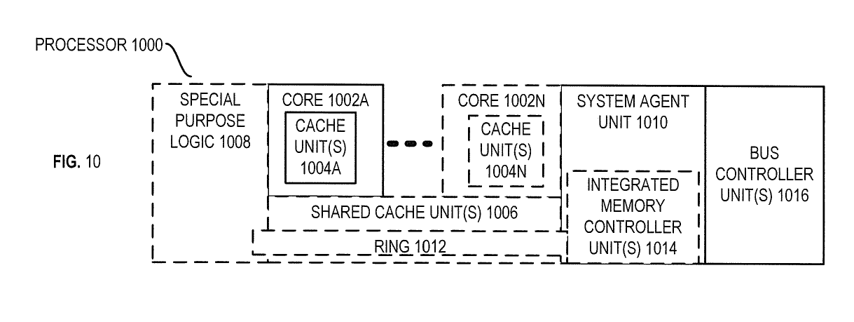

FIG. 10 is a block diagram of a processor 1000 that may have more than one core, may have an integrated memory controller, and may have integrated graphics according to embodiments of the invention. The solid lined boxes in FIG. 10 illustrate a processor 1000 with a single core 1002A, a system agent 1010, a set of one or more bus controller units 1016, while the optional addition of the dashed lined boxes illustrates an alternative processor 1000 with multiple cores 1002A-N, a set of one or more integrated memory controller unit(s) 1014 in the system agent unit 1010, and special purpose logic 1008.

Thus, different implementations of the processor 1000 may include: 1) a CPU with the special purpose logic 1008 being integrated graphics and/or scientific (throughput) logic (which may include one or more cores), and the cores 1002A-N being one or more general purpose cores (e.g., general purpose in-order cores, general purpose out-of-order cores, a combination of the two); 2) a coprocessor with the cores 1002A-N being a large number of special purpose cores intended primarily for graphics and/or scientific (throughput); and 3) a coprocessor with the cores 1002A-N being a large number of general purpose in-order cores. Thus, the processor 1000 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1000 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1006, and external memory (not shown) coupled to the set of integrated memory controller units 1014. The set of shared cache units 1006 may include one or more mid-level caches, such as level 2 (L2), level 3 (L3), level 4 (L4), or other levels of cache, a last level cache (LLC), and/or combinations thereof. While in one embodiment a ring based interconnect unit 1012 interconnects the integrated graphics logic 1008, the set of shared cache units 1006, and the system agent unit 1010/integrated memory controller unit(s) 1014, alternative embodiments may use any number of well-known techniques for interconnecting such units. In one embodiment, coherency is maintained between one or more cache units 1006 and cores 1002-A-N.

In some embodiments, one or more of the cores 1002A-N are capable of multi-threading. The system agent 1010 includes those components coordinating and operating cores 1002A-N. The system agent unit 1010 may include for example a power control unit (PCU) and a display unit. The PCU may be or include logic and components needed for regulating the power state of the cores 1002A-N and the integrated graphics logic 1008. The display unit is for driving one or more externally connected displays.

The cores 1002A-N may be homogenous or heterogeneous in terms of architecture instruction set; that is, two or more of the cores 1002A-N may be capable of execution the same instruction set, while others may be capable of executing only a subset of that instruction set or a different instruction set.

### Exemplary Computer Architectures

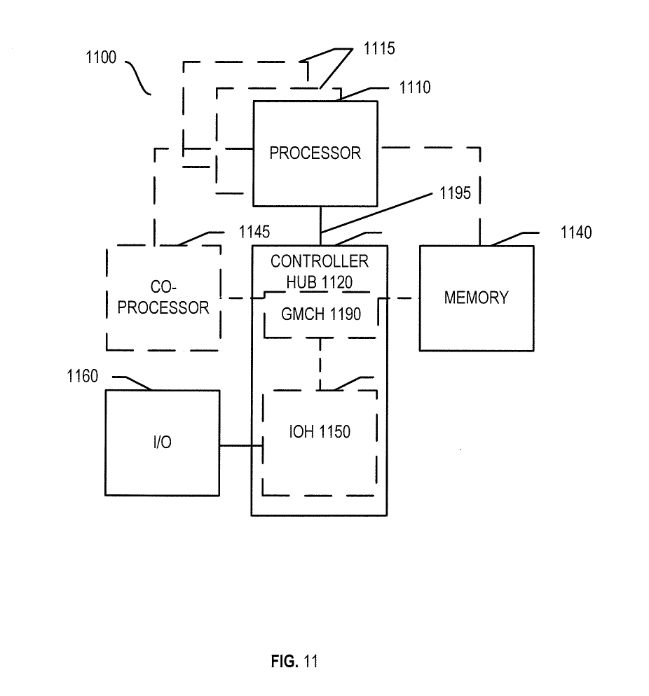

FIGS. 11-14 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 11, shown is a block diagram of a system 1100 in accordance with one embodiment of the present invention. The system 1100 may include one or more processors 1110, 1115, which are coupled to a controller hub 1120. In one embodiment the controller hub 1120 includes a graphics memory controller hub (GMCH) 1190 and an Input/Output Hub (IOH) 1150 (which may be on separate chips); the GMCH 1190 includes memory and graphics controllers to which are coupled memory 1140 and a coprocessor 1145; the IOH 1150 is couples input/output (I/O) devices 1160 to the GMCH 1190. Alternatively, one or both of the memory and graphics controllers are integrated within the processor (as described herein), the memory 1140 and the coprocessor 1145 are coupled directly to the processor 1110, and the controller hub 1120 in a single chip with the IOH 1150.

The optional nature of additional processors 1115 is denoted in FIG. 11 with broken lines. Each processor 1110, 1115 may include one or more of the processing cores described herein and may be some version of the processor 1000.

The memory 1140 may be, for example, dynamic random access memory (DRAM), phase change memory (PCM), or a combination of the two. For at least one embodiment, the controller hub 1120 communicates with the processor(s) 1110, 1115 via a multi-drop bus, such as a frontside bus (FSB), point-to-point interface such as QuickPath Interconnect (QPI), or similar connection 1195.

In one embodiment, the coprocessor 1145 is a special-purpose processor, such as, for example, a high-throughput MIC processor, a network or communication processor, compression engine, graphics processor, GPGPU, embedded processor, or the like. In one embodiment, controller hub 1120 may include an integrated graphics accelerator.

There can be a variety of differences between the physical resources 1110, 1115 in terms of a spectrum of metrics of merit including architectural, microarchitectural, thermal, power consumption characteristics, and the like.

In one embodiment, the processor 1110 executes instructions that control data processing operations of a general type. Embedded within the instructions may be coprocessor instructions. The processor 1110 recognizes these coprocessor instructions as being of a type that should be executed by the attached coprocessor 1145. Accordingly, the processor 1110 issues these coprocessor instructions (or control signals representing coprocessor instructions) on a coprocessor bus or other interconnect, to coprocessor 1145. Coprocessor(s) 1145 accept and execute the received coprocessor instructions.

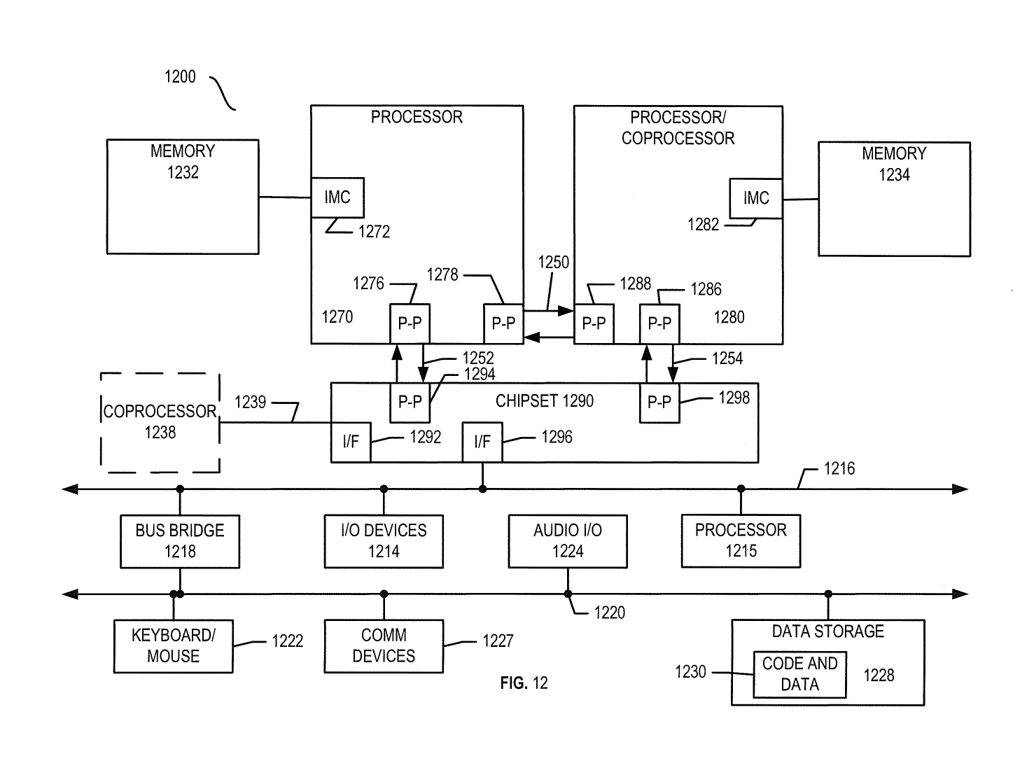

Referring now to FIG. 12, shown is a block diagram of a first more specific exemplary system 1200 in accordance with an embodiment of the present invention. As shown in FIG. 12, multiprocessor system 1200 is a point-to-point interconnect system, and includes a first processor 1270 and a second processor 1280 coupled via a point-to-point interconnect 1250. Each of processors 1270 and 1280 may be some version of the processor 1000. In one embodiment of the invention, processors 1270 and 1280 are respectively processors 1110 and 1115, while coprocessor 1238 is coprocessor 1145. In another embodiment, processors 1270 and 1280 are respectively processor 1110 coprocessor 1145.

Processors 1270 and 1280 are shown including integrated memory controller (IMC) units 1272 and 1282, respectively. Processor 1270 also includes as part of its bus controller units point-to-point (P-P) interfaces 1276 and 1278; similarly, second processor 1280 includes P-P interfaces 1286 and 1288. Processors 1270, 1280 may exchange information via a point-to-point (P-P) interface 1250 using P-P interface circuits 1278, 1288. As shown in FIG. 12, IMCs 1272 and 1282 couple the processors to respective memories, namely a memory 1232 and a memory 1234, which may be portions of main memory locally attached to the respective processors.

Processors 1270, 1280 may each exchange information with a chipset 1290 via individual P-P interfaces 1252, 1254 using point to point interface circuits 1276, 1294, 1286, 1298. Chipset 1290 may optionally exchange information with the coprocessor 1238 via a high-performance interface 1239. In one embodiment, the coprocessor 1238 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1290 may be coupled to a first bus 1216 via an interface 1296. In one embodiment, first bus 1216 may be a Peripheral Component Interconnect (PCI) bus, or a bus such as a PCI Express bus or another third generation I/O interconnect bus, although the scope of the present invention is not so limited.

As shown in FIG. 12, various I/O devices 1214 may be coupled to first bus 1216, along with a bus bridge 1218 which couples first bus 1216 to a second bus 1220. In one embodiment, one or more additional processor(s) 1215, such as coprocessors, high-throughput MIC processors, GPGPU's, accelerators (such as, e.g., graphics accelerators or digital signal processing (DSP) units), field programmable gate arrays, or any other processor, are coupled to first bus 1216. In one embodiment, second bus 1220 may be a low pin count (LPC) bus. Various devices may be coupled to a second bus 1220 including, for example, a keyboard and/or mouse 1222, communication devices 1227 and a storage unit 1228 such as a disk drive or other mass storage device which may include instructions/code and data 1230, in one embodiment. Further, an audio I/O 1224 may be coupled to the second bus 1220. Note that other architectures are possible. For example, instead of the point-to-point architecture of FIG. 12, a system may implement a multi-drop bus or other such architecture.

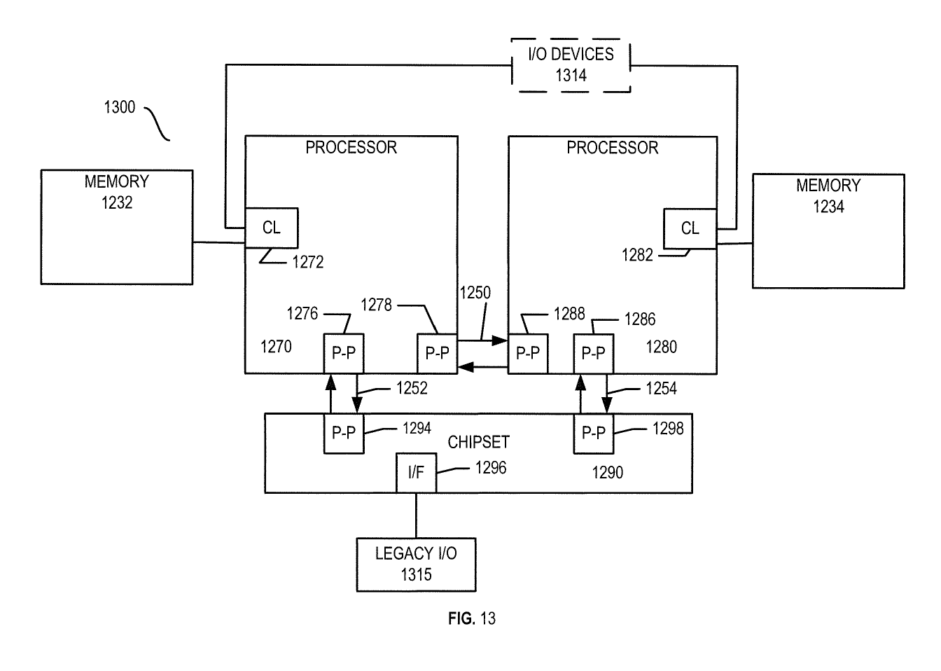

Referring now to FIG. 13, shown is a block diagram of a second more specific exemplary system 1300 in accordance with an embodiment of the present invention. Like elements in FIGS. 12 and 13 bear like reference numerals, and certain aspects of FIG. 12 have been omitted from FIG. 13 in order to avoid obscuring other aspects of FIG. 13.

FIG. 13 illustrates that the processors 1270, 1280 may include integrated memory and I/O control logic (“CL”) 1272 and 1282, respectively. Thus, the CL 1272, 1282 include integrated memory controller units and include I/O control logic. FIG. 13 illustrates that not only are the memories 1232, 1234 coupled to the CL 1272, 1282, but also that I/O devices 1314 are also coupled to the control logic 1272, 1282. Legacy I/O devices 1315 are coupled to the chipset 1290.

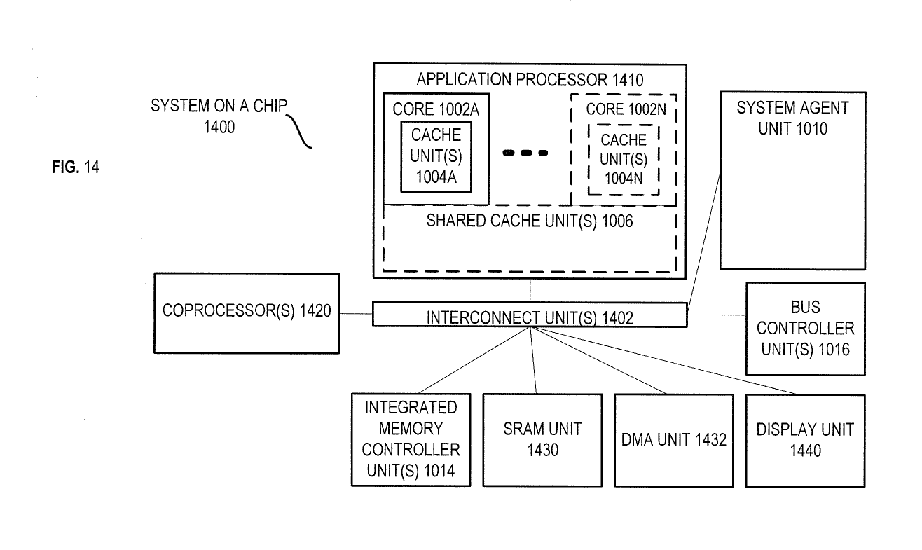

Referring now to FIG. 14, shown is a block diagram of a SoC 1400 in accordance with an embodiment of the present invention. Similar elements in FIG. 10 bear like reference numerals. Also, dashed lined boxes are optional features on more advanced SoCs. In FIG. 14, an interconnect unit(s) 1402 is coupled to: an application processor 1410 which includes a set of one or more cores 202A-N and shared cache unit(s) 1006; a system agent unit 1010; a bus controller unit(s) 1016; an integrated memory controller unit(s) 1014; a set or one or more coprocessors 1420 which may include integrated graphics logic, an image processor, an audio processor, and a video processor; an static random access memory (SRAM) unit 1430; a direct memory access (DMA) unit 1432; and a display unit 1440 for coupling to one or more external displays. In one embodiment, the coprocessor(s) 1420 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1230 illustrated in FIG. 12, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

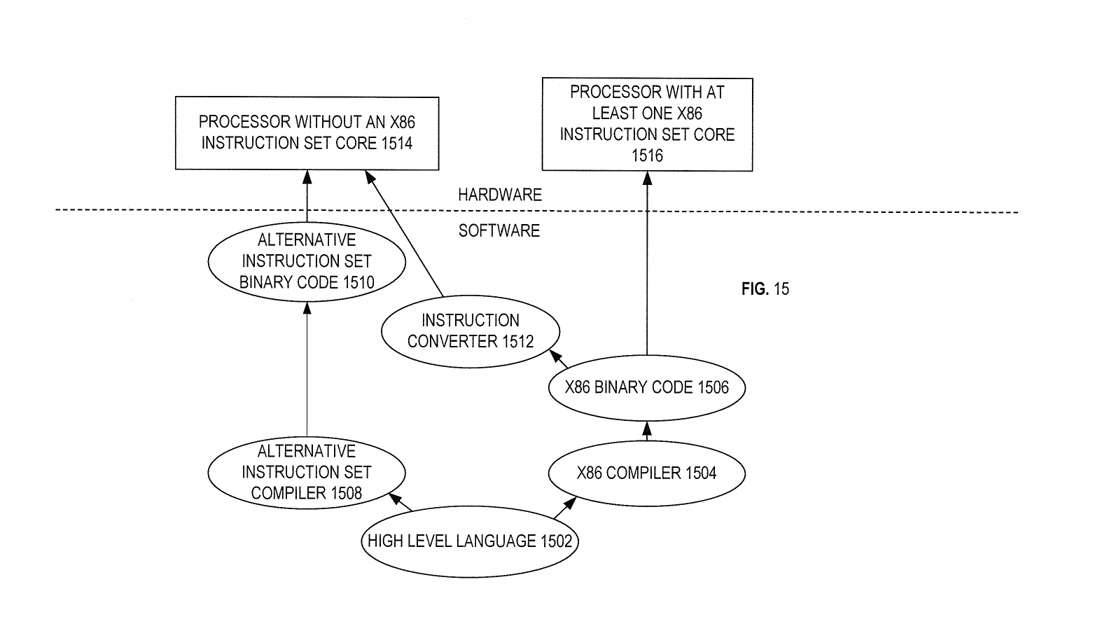

FIG. 15 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 15 shows a program in a high level language 1502 may be compiled using an x86 compiler 1504 to generate x86 binary code 1506 that may be natively executed by a processor with at least one x86 instruction set core 1516. The processor with at least one x86 instruction set core 1516 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1504 represents a compiler that is operable to generate x86 binary code 1506 (e.g., object code) that can, with or without additional linkage processing, be executed on the processor with at least one x86 instruction set core 1516. Similarly, FIG. 15 shows the program in the high level language 1502 may be compiled using an alternative instruction set compiler 1508 to generate alternative instruction set binary code 1510 that may be natively executed by a processor without at least one x86 instruction set core 1514 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1512 is used to convert the x86 binary code 1506 into code that may be natively executed by the processor without an x86 instruction set core 1514. This converted code is not likely to be the same as the alternative instruction set binary code 1510 because an instruction converter capable of this is difficult to make; however, the converted code will accomplish the general operation and be made up of instructions from the alternative instruction set. Thus, the instruction converter 1512 represents software, firmware, hardware, or a combination thereof that, through emulation, simulation or any other process, allows a processor or other electronic device that does not have an x86 instruction set processor or core to execute the x86 binary code 1506.

In the description and claims, the terms “coupled” and/or “connected,” along with their derivatives, have be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. For example, logic may be coupled with a decoder and/or a cache through one or more intervening components. In the figures, arrows are used to show couplings and/or connections.

In the description and claims, the term “logic” may have been used. As used herein, the term logic may include hardware, firmware, software, or various combinations thereof. Examples of logic include integrated circuitry, application specific integrated circuits, analog circuits, digital circuits, programmed logic devices, memory devices including instructions, etc. In some embodiments, the logic may include transistors and/or gates potentially along with other circuitry components.

In the description above, specific details have been set forth in order to provide a thorough understanding of the embodiments. However, other embodiments may be practiced without some of these specific details. The scope of the invention is not to be determined by the specific examples provided above but only by the claims below. All equivalent relationships to those illustrated in the drawings and described in the specification are encompassed within embodiments. In other instances, well-known circuits, structures, devices, and operations have been shown in block diagram form or without detail in order to avoid obscuring the understanding of the description. In some cases these multiple components shown in the drawings may be incorporated into one component. Where a single component has been shown and described, in some cases this single component may be separated into two or more components.

Certain methods disclosed herein have been shown and described in a basic form, although operations may optionally be added to and/or removed from the methods. In addition, a particular order of the operations may have been shown and/or described, although alternate embodiments may perform certain operations in different order, combine certain operations, overlap certain operations, etc.

Certain operations may be performed by hardware components and/or may be embodied in a machine-executable or circuit-executable instruction that may be used to cause and/or result in a hardware component (e.g., a processor, potion of a processor, circuit, etc.) programmed with the instruction performing the operations. The hardware component may include a general-purpose or special-purpose hardware component. The operations may be performed by a combination of hardware, software, and/or firmware. The hardware component may include specific or particular logic (e.g., circuitry potentially combined with software and/or firmware) that is operable to execute and/or process the instruction and store a result in response to the instruction (e.g., in response to one or more microinstructions or other control signals derived from the instruction).

Reference throughout this specification to “one embodiment,” “an embodiment,” “one or more embodiments,” “some embodiments,” for example, indicates that a particular feature may be included in the practice of the invention but is not necessarily required to be. Similarly, in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects lie in less than all features of a single disclosed embodiment. Thus, the claims following the Detailed Description are hereby expressly incorporated into this Detailed Description, with each claim standing on its own as a separate embodiment of the invention.

What is claimed is:

1. A method comprising:
changing a state of a portion of a structure of a processor to a sequestered state, wherein in the sequestered state components of the processor are not able to access the portion of the structure but are able to access one or more other portions of the structure;
modifying non-architecturally visible data in the portion of the structure to modified non-architecturally visible data while the portion of the structure is in the sequestered state; and
changing the state of the portion of the structure from the sequestered state to a non-sequestered state after modifying the non-architecturally visible data in the portion of the structure.

2. The method of claim 1, wherein changing the state to the sequestered state comprises changing the state of a portion of a structure selected from a cache, a register set, a translation lookaside buffer (TLB), and an address decoder, to the sequestered state.

3. The method of claim 1, wherein changing the state to the sequestered state comprises changing the state of a line of a cache to the sequestered state, wherein modifying comprises modifying data selected from at least one of a tag of the line and error correcting code data of the line, and wherein changing the state to the non-sequestered state comprises changing the state of the line of the cache to a non-sequestered state selected from a modified state, an exclusive state, a shared state, and an invalid state.

4. The method of claim 1, wherein changing the state to the sequestered state comprises changing the state of a register of a register set, and wherein modifying comprises modifying data selected from at least one of error correction data and scoreboard data for the register.

5. The method of claim 1, wherein changing the state to the sequestered state is performed responsive to a first instruction, wherein modifying the non-architecturally visible data is performed responsive to a second instruction, and wherein changing the state to the non-sequestered state is performed responsive to a third instruction.

6. The method of claim 5, wherein each of the first, second, and third instructions is a structure access instruction.

7. The method of claim 1, wherein changing the state to the sequestered state is performed responsive to an instruction, wherein the instruction indicates the structure and is capable of indicating a plurality of different structures each selected from a cache, a register set, an address decoder, and a translation lookaside buffer (TLB).

8. The method of claim 1, wherein changing the state to the sequestered state comprises changing a state of line of a cache in response to an instruction, and wherein the instruction operable to indicate either that the cache is, or is not, to generate error correction code for the modified non-architecturally visible data.

9. The method of claim 1, wherein modifying comprises modifying the non-architecturally visible data while the components access the one or more other portions of the structure.

10. The method of claim 1, wherein changing the state to the sequestered state comprises coherently changing the state to the sequestered state including storing the non-architecturally visible data in a storage location prior to modifying the non-architecturally visible data.

11. The method of claim 1, wherein changing the state to the sequestered state comprises a higher-privilege level component changing the state to the sequestered state, and wherein the components that are not able to access the portion of the structure when in the sequestered state comprise lower-privilege level components that each have a lower-privilege level than the higher-privileged level component.

12. A processor comprising:
a structure of the processor having a non-architecturally visible data; and
logic coupled with the structure, the logic, in response to one or more instructions, to:
change a state of a portion of the structure to a sequestered state, wherein in the sequestered state components of the processor are not able to access the portion of the structure but are able to access one or more other portions of the structure;
modify the non-architecturally visible data in the portion of the structure to modified non-architecturally visible data, while the portion of the structure is in the sequestered state; and
change the state of the portion of the structure from the sequestered state to a non-sequestered state after modifying the non-architecturally visible data in the portion of the structure.

13. The processor of claim 12, wherein the logic is to change the state to the sequestered state in response to a first instruction, wherein the logic is to modify the non-architecturally visible data in response to a second instruction, and wherein the logic is to change the state to the non-sequestered state in response to a third instruction.

14. The processor of claim 13, wherein each of the first, second, and third instructions has a same opcode.

15. The processor of claim 12, wherein the structure is selected from a cache, a register set, a translation lookaside buffer (TLB), and an address decoder.

16. The processor of claim 12, wherein the structure comprises a cache, wherein the portion of the cache comprises a cache line, and wherein the logic, in response to the one or more instructions, is to modify data selected from at least one of a tag of the cache line and error correcting code data of the cache line.

17. The processor of claim 12, wherein the structure comprises a register set, wherein the portion of the register set comprises a register, and wherein the logic, in response to the one or more instructions, is to modify data selected from at least one of error correction data and scoreboard data of the register.

18. The processor of claim 12, wherein the logic is to change the state to the sequestered state in response to an instruction that indicates the structure and is capable of indicating a plurality of different structures each selected from a cache, a register set, an address decoder, and a translation lookaside buffer (TLB).

19. The processor of claim 12, wherein the structure comprises a cache and the portion of the cache comprises a cache line, and wherein the logic is to modify the non-architecturally visible data in response to an instruction that is operable to indicate either that the cache is, or is not, to generate error correction code for the modified non-architecturally visible data.

20. The processor of claim 12, wherein the components are able to access the one or more other portions of the structure while the logic modifies the non-architecturally visible data.

21. The processor of claim 12, wherein the logic, in response to the one or more instructions, is to coherently change the state to the sequestered state including storing the non-architecturally visible data in a storage location prior to modifying the non-architecturally visible data.

22. A system comprising:
an interconnect;
a processor coupled with the interconnect, the processor having a structure including non-architecturally visible data, the processor operable, in response to one or more instructions, to:
change a state of a portion of the structure to a sequestered state, wherein in the sequestered state components of the processor are not able to access the portion of the structure but are able to access one or more other portions of the structure; and
modify the non-architecturally visible data in the portion of the structure to modified non-architecturally visible data, while the portion of the structure is in the sequestered state; and
a dynamic random access memory (DRAM) coupled with the interconnect.

23. The system of claim 22, wherein the structure comprises a cache, wherein the portion of the cache comprises a cache line, and wherein the processor unit, in response to the one or more instructions, is to modify data selected from a tag of the cache line and error correcting code data of the cache line.

24. The system of claim 22, wherein the instruction is operable to indicate the structure as one of a plurality of different types of structures.

25. An article of manufacture comprising:
a machine-readable storage medium including one or more solid data storage materials, the machine-readable storage medium storing one or more instructions,
the one or more instructions if processed by a machine operable to cause the machine to perform operations comprising:
changing a state of a portion of a structure of a processor to a sequestered state, wherein in the sequestered state components of the processor are not able to access the portion of the structure but are able to access one or more other portions of the structure; and
modifying non-architecturally visible data in the portion of the structure to modified non-architecturally visible data while the portion of the structure is in the sequestered state.

26. The article of manufacture of claim 25, wherein a first structure access instruction is to cause the machine to change the state and a second structure access instruction is to cause the machine to modify the non-architecturally visible data.

27. The article of manufacture of claim 25, wherein the one or more instructions include an instruction operable to indicate whether or not error correction is to be performed on the modified non-architecturally visible data.
